(19) United States
(12) Patent Application Publication
(10) Pub. No.: US 2020/0017031 A1
(43) Pub. Date: Jan. 16, 2020

(54) ADJUSTING DEVICE FOR PROVIDING A STORAGE COMPARTMENT HAVING A STORAGE SPACE

(71) Applicant: Brose Fahrzeugteile GmbH & Co. Kommanditgesellschaft, Coburg, Coburg (DE)

(72) Inventors: Markus BAUERNFEIND, Coburg (DE); Fabian LANG, Ergersheim (DE); Michael HOEPPEL, Bad Staffelstein (DE); Volker DEINHARD, Bamberg (DE); Mario Stegerer, Gundelsheim (DE)

(73) Assignee: Brose Fahrzeugteile GmbH & Co. Kommanditgesellschaft, Coburg, Coburg (DE)

(21) Appl. No.: 16/482,071

(22) PCT Filed: Jan. 29, 2018
(86) PCT No.: PCT/EP2018/052059

§ 371 Date: Oct. 3, 2019

(30) Foreign Application Priority Data
Feb. 1, 2017 (DE) 10 2017 201 626.4

(51) Int. Cl. B60R 7/00; B60N 3/00; B60R 7/02; B60R 7/08

(52) U.S. Cl. CPC B60R 7/005; B60N 3/004; B60Y 2400/30; B60R 7/08; B60R 7/02

(57) ABSTRACT

An adjusting device for providing a storage compartment having a storage space the volume of which is variable, including an adjustable part by means of which at least part of a wall delimiting the storage space is defined and which can be adjusted between an initial position and at least one adjustment position, the volume of the storage space in the initial position of the adjustable part being different from that in the adjustment position of the adjustable part. The adjusting device may include at least one link chain with a plurality of chain links and/or the adjustable part can be adjusted to an adjustment position in which an exterior face of the adjustable part, being opposite an interior face of the adjustable part facing the storage space, defines a support surface as part of a table formed by the adjustable part.

### CROSS-REFERENCE TO RELATED APPLICATIONS

This application is the U.S. National Phase of PCT/EP2018/052059 filed Jan. 29, 2018, which claims priority to DE 10 2017 201 626.4 filed Feb. 1, 2017, the disclosures of which are hereby incorporated in their entirety by reference herein.

### TECHNICAL FIELD

The present disclosure relates to an adjusting device for providing a storage compartment having a storage space, the volume of the storage space being variable.

### BACKGROUND

The use of storage compartments is widely known, in particular in the automotive sector. Storage compartments of this type are provided, for example, in the region of the dashboard of a motor vehicle or in the central console. The storage space provided by storage compartments is usually not variable. Rather, a defined volume which is accessible by way of a typically pivotable cover or rear flap is provided. Storage compartments of this type are usually provided for stowing comparatively small items.

In practice as it also known for a depositing face to be configured on an internal side of the pivotable cover or flap, such that a bottle or cup holder is provided by way of an opened flap or cover.

However, there is a demand for storage compartments which provide an additional use and/or offer additional operating comfort.

### SUMMARY

Accordingly, an adjusting device for providing a storage compartment having a storage space, the volume of the storage space being variable, is proposed. The adjusting device may include an adjusting part by means of which a wall that at least partially delimits the storage space is defined and which is adjustable at least between initial position and at least one adjustment position, wherein the volume of the storage space usable for stowing items is different in the initial position of the adjusting part and the adjustment position of the adjusting part. In the initial position of the adjusting part herein, a smaller volume is usually provided than in the at least one additional adjustment position of the adjusting part. The adjusting device for adjusting the adjustment part between the initial position and the at least one adjustment position may include at least one link chain having a plurality of chain links.

On account of the adjusting device equipped with a link chain, the adjusting part may not only be adjusted in a comfortable and highly variable manner so as to enable different volumes of the storage space. Rather, a comparatively compact design of the adjusting device and thus of the storage compartment is possible on account of the use of at least one link chain for adjusting the adjusting part.

To this end, the at least one link chain has a plurality of chain links which in a non-deployed state are mutually repositionable such that non-deployed portions of the link chain are flexible. The chain links in a deployed state bear on one another in a blocking manner such that a deployed portion of the link chain is rigid, and the adjusting part is held in the desired adjustment position. The adjusting part is thus securely held by way of the deployed portions of the at least one link chain in order for a changed volume for the storage space of the storage compartment to be permanently predefined. The storage space herein may be closed by way of the adjusting part, but this is not mandatory. A separately adjustable, pivotable and/or displaceable, cover or flap may also be additionally provided for closing the storage space. The adjusting part that is adjustable by means of the at least one link chain in this variant predefines above all a variable volume of the storage space and optionally also of an access opening by way of which the interior of the storage space is accessible. The access opening in this instance may be closable by way of a separate cover or a separate flap.

In the case of the at least one link chain, the individual chain links may be mutually braced so that the chain links in the deployment of a portion of the link chain bear on one another in a blocking manner and the deployed portion of the link chain is rigid. A tensioning installation which may have at least one elongate tensioning means such as, for example, a tensioning strap or a tensioning cable, for example, which extends along the individual chain links of the link chain and optionally through the chain links so as to mutually brace the chain links may be provided for the mutual bracing of the chain links, for example.

Alternatively or additionally, the individual chain links may be equipped with a locking installation so as to be mutually locked in a blocking manner when deployed and so as to be unlocked again when retracted such that the link chain by way of a deployed portion is rigid and in the retracted state is flexible on account of chain links that are repositionable relative to one another.

In one or more embodiments, of the adjusting device, the adjusting part by means of the at least one link chain is pivotable and adjustable in a translatory manner. The adjusting part from the initial position thereof may be adjustable in a translatory manner to at least one first adjustment position, and by pivoting about a pivot axis is adjustable to at least one second adjustment position which is different from the first adjustment position. At least one of the first and the second adjustment position is herein may also be assumed by the adjusting part by superimposing a pivoting movement with a translatory movement. In one refinement, both the pivoting movement as well as the transitory adjusting movement (along an adjustment axis that runs in a rectilinear manner) may be controllable and drivable by the at least one link chain.

For example, the adjusting part from the initial position is pivotable by more than 45°. For example, an ideally large pivoting range ≥45° herein enables the volume of the storage space to be adapted in a variable manner. Rather, the geometry or the shape, respectively, of the storage space hereby may also be adapted in a comparatively flexible manner by pivoting the adjusting part.

Alternatively, or additionally, the adjusting part may be pivotable about a pivot axis which run so as to be substantially or exactly perpendicular to an adjustment direction along which the adjusting part from the initial position is likewise adjustable in a translatory manner. Consequently, the adjusting part in this variant by means of the at least one link chain is a relocatable along an adjustment direction, on the one hand, and simultaneously pivotable about an adjustment axis which runs so as to be substantially or perpendicular to the adjustment direction. This likewise offers a greater flexibility for the variable adaptation of the storage space volume.

In one or more embodiments, the adjusting part in the initial position by way of an external side defines an external visible face of the storage compartment. For example, the adjusting part herein configures a front of the storage compartment, the front by means of the link chain being adjustable, such as adjustable in a translatory manner and/or pivotable, in order for the volume of a storage space of the storage compartment be able to be adapted in a variable manner. The adaptation of the storage space volume may be performed in an automated manner, for example, as a function of a loading state of the storage space, and/or so as to be controlled by a user.

As one example of enhanced ease of operation, the at least one link chain at least one drive installation of the adjusting device may be adjustable in a manner activated by an external force. To this end, the drive installation has, for example, a hydraulic, pneumatic, and/or electromotive drive in order for the link chain be at least partially retracted and deployed and to thus adjust the adjusting part. For transmitting the force from the at least one drive to the link chain, the drive installation may furthermore be equipped, for example, with a rack-and-pinion drive, a worm gear mechanism, a spindle drive, or a traction means such as a cable pull, or a thrust means such as a cable (that is rigid under thrust).

In one or more embodiments, the drive installation may include a gear mechanism for gearing a drive input torque to a drive output torque by means of which chain links of the at least one link chain are deployed from a chain housing and are retracted into a chain housing. A transmission of the drive input torque to a chain-link of the link chain herein is performed by means of a toothing that is configured on a chain-link, for example. In the case of a spindle drive, for example, a spindle nut on a spindle of the spindle drive is relocated longitudinally along a spindle axis so as to hereby adjust a (drive) chain-link that is connected to the spindle nut along a guide and to thus retract and deploy the at least one link chain. In the use of a traction means or a thrust means, for example, the adjusting force may be transmitted by way of the traction means or thrust means to a last (end) chain-link of the at least one link chain to which the traction means or shoe means is connected, so as to hereby retract and deploy the other deployable end of the at least one link chain (the end being connected to the adjusting part).

In yet another embodiment, the drives and/or the link chains may be coupled to one another such that at least two link chains of the adjusting device are drivable, optionally in a synchronous manner, by way of a common motorized drive of a drive installation. In such a variant at least two link chains which may be retracted and/or deployed by means of a common drive of the drive installation are thus provided for the adjustment of the adjusting part in order for the volume of the storage space to be varied. For example, a coupling of link chains that are spaced apart in spatial terms, so as to be able to drive the link chains by way of the common motorized drive, is implemented by way of a mechanical coupling member such as, for example, a shaft, such as a flexible shaft, and/or a belt.

In one or more embodiments, an individual motorized drive is in each case provided for each of a plurality of link chains in order for the adjusting part to be adjusted. The motorized drives herein may also be actuatable in a mutually independent manner so as to adjust in a dissimilar manner portions of the adjusting part that are in each case connected to one link chain and hereby additionally vary the shape of the storage space. In an alternative variant of embodiment, one motorized drive is in each case provided for adjusting two link chains.

The adjusting device for guiding and accommodating the at least one link chain, for example, in the initial position of the adjusting part, may have a chain housing from which the at least one link chain by means of a drive installation is at least partially deployable so as to then adjust the adjusting part from the initial position thereof to the at least one adjustment position. The chain links of the link chain herein are mutually repositionable in the chain housing, on account of which a portion of the link chain that lies in the chain housing is flexible and may be deflected. This facilitates the accommodation of the link chain in an installation-space-saving manner and promotes the overall compact configuration of the storage compartment despite the additional variability of the latter.

The link chain within the chain housing may be deflected once or multiple times, optionally also in different spatial directions. For example, one variant provides that the chain housing is configured for a deflection of the link chain by more than 45° when retracting. This may include, for example, a deflection by more than 60°, for example in the range from 80° to 100°, or as one example by approximately 90°.

In one or more embodiments, the chain housing which is provided for accommodating at least part of the link chain when the adjusting part is situated in the initial position thereof, is configured so as to be L-shaped or spiral-shaped. In the case of a chain housing that is configured so as to be L-shaped, the link chain is thus deflected by approximately 90° in relation to a deployment direction along which the link chain may be deployed from the chain housing. In the case of a chain housing that is configured so as to be spiral-shaped (that is to say so as to follow a spiral line), the requirement in terms of installation space when using a plurality of chain housings may be additionally reduced when chain housings which are in each case configured so as to be spiral-shaped are provided so as to be mutually interlocked.

In another example, the entire chain housing may be mounted so as to be rotatable about a rotation axis. This may include a variant in which the drive installation is mounted so as to be rotatable conjointly with the chain housing and the motorized drive unit about a rotation axis. The deployment direction of the at least one link chain may be variable on account of the rotatable of the chain housing, for example to create a pivoting movement of the adjusting part by way of the deploying link chain. For example, this is provided in one variant in order for the adjusting part be able to be established in an adjustment position in which the adjusting part defines a depositing face as part of a table formed by the adjusting part. An additional function is thus integrated in the storage compartment by way of the adjusting part, such that the storage compartment may also provide a table when required. For example, the adjusting part herein from the initial position may be adjustable to a plurality of different (first) adjustment positions by way of which the storage space of the storage compartment is preassigned volumes of dissimilar sizes. The adjusting part may additionally be adjustable to at least one further (second) adjustment position which is referred to as the table position and in which by way of the adjusting part a depositing face is defined as part of a table, the table in the first adjustment position not being utilizable for predefining dissimilar volumes of the storage space.

In a refinement based thereon, the adjusting part is adjustable to a (second) adjustment position in which an external side of the adjusting part that lies opposite an internal side of the adjusting part that faces the storage space defines the depositing face for the table formed by the adjusting part.

In one variant of one or more embodiments, the table formed by the adjusting part herein, on the external side, may have a blocking element which project so as to be raised in relation to the depositing face so as to prevent that an item placed on the table may slide off the depositing face. In one variant, the blocking element may be configured by a peripheral piece provided on the adjusting part. Such a peripheral piece herein may also be mounted so as to be foldable on the adjusting part, for example, in order for the peripheral piece be able to be folded onto the external side of the adjusting part only in the table position of the adjusting part. In principle, a plurality of blocking elements, that may be in the form of foldable peripheral pieces, may also be provided on the adjusting part.

Alternatively or additionally, the adjusting part may be provided with a concavity which in the table position of the adjusting part is depressed in relation to the depositing face. Such a concavity may define, for example, a bowl or a trough on the depositing face in which items may be received.

As has already been explained above, a plurality of link chains for adjusting the adjusting part may also be provided in one or more embodiments. For example, for adjusting the adjusting part, the latter being, for example, a plate-shaped front of the storage compartment, at least two of the chain links may be adjustable in a mutually independent manner for the volume and/or the shape of the storage space to be varied. The two link chains in this instance herein may be deployable from the chain housing and retractable into the latter in a mutually independent manner, for example. The two chain links herein may have a common chain housing in which the two chain links are conjointly accommodated when the adjusting part is situated in the initial position thereof. Alternatively, retracting the two chain links into two different chain housings and deploying the two chain links from two different chain housings is likewise possible.

Each of the link chains or one pair of link chains may be assigned a drive installation by means of which the respective link chain or the pair of link chains is adjustable in a manner activated by an external force. For example, the adjusting device for adjusting the adjusting part may include four link chains which are in each case connected to the adjusting part and by way of a drive installation or a plurality of drive installations having in each case one motorized drive are adjustable in a manner activated by an external force.

For example, the adjusting device for adjusting the adjusting part may include four link chains which are in each case connected to the adjusting part at 104 corner points of a virtual rectangle. The adjustment of the adjusting part by way of the different link chains is extremely flexible in that the adjusting part by way of the four link chains is acted on at four corner points of a virtual rectangle. Different portions of the adjusting part in the region of the four corner points may thus be relocated to a dissimilar extent in relation to the initial position and also in a mutually relative manner so as to on account thereof vary the volume and/or the shape of the storage space. For example, the adjusting part may be readily pivoted in a targeted manner by (further) deploying to link chains, while the remaining two link chains remain arrested or are deployed to a lesser extent. On account thereof, not only the volume of the storage space but also the geometric basic shape thereof is varied when an internal wall of the storage space is defined by way of the adjusting part.

Alternatively or additionally to a connection of the four link chains to the adjusting part at four corner points of a virtual rectangle, to link chains may be adjustable along a first virtual plane, and to further link chains may be adjustable, for example, in a mutually synchronous or non-synchronous manner, along the second virtual plane which runs so as to be parallel to the first virtual plane. In this variant of embodiment, the deployed link chains consequently run so as to be mutually parallel in pairs. This facilitates, for example, predefining dissimilar adjusting movements of the adjusting part and for example, in forcing a pivoting movement of the adjusting part by way of the four link chains. In this instance, a pivot axis for the adjusting part may lie in one of the first and the second virtual planes.

In the case of an adjusting device having at least or exactly 4 link chains, the adjusting device may include at least two chain housings which are disposed on top of one another, for example in pairs, and specifically along a spatial axis which run so as to be substantially or exactly perpendicular to a spatial axis along which the adjusting part is adjustable in a translatory manner. For example, if the adjusting device having the storage compartment is installed according to the intended use in such a manner that the adjustment of the adjusting part is performed substantially along a horizontal, the chain housings for the individual link chains here lie so as to be on top of one another along a vertical.

Alternatively or additionally, in one or more embodiments, it may be provided for the compact accommodation of the chain housings that at least one chain housing for at least one link chain extends at least partially about another chain housing of another link chain. Consequently, the one chain housing here at least partially surrounds the other chain housing and extends along the external contour of the other chain housing. Additionally, the two chain housings may also run so as to be partially mutually inclined.

In principle, the adjusting part may be adjustable relative to a support component of the adjustment direction, the support component defining a rear wall for the storage space, and/or a drive installation of the adjusting device being held on the support component. In one or more embodiments, the support component has at least one deployment opening from which the at least one link chain is deployable so as to adjust the adjusting part from the initial position thereof. In terms of a deployment direction of a link chain, the support component is thus disposed ahead of a chain housing for the link chain so that the link chain when retracting makes its way by way of the deployment opening into the chain housing that lies behind the support component.

The support component may for example, be a planar component which has a plurality of deployment openings for a plurality of different link chains, the deployment openings in spatial terms being mutually offset.

In one or more embodiments, the adjustment part is connected to at least one flexible lateral part that is capable of being rolled and/or folded up and by means of which a further wall that delimits the storage space is defined. Accordingly, one of a plurality of walls of the storage space is defined by means of the adjustable adjusting part, and another wall is defined by a flexible lateral part that is capable of being rolled and/or folded up. For example, the adjusting part forms an adjustable front side or front wall of the storage space and is connected to 2 flexible mutually opposite lateral parts that are capable of being rolled and/or folded up. The respective lateral part when adjusting the adjusting part from the initial position may thus be elongated, rolled up or unrolled and/or unfolded in order for a volume of the storage space to be increased. When the resetting the adjusting part from an adjustment position in the direction of the initial position, the respective lateral part is compressed again, or rolled up and/or folded up or unfolded, on account of which the volume of the storage space is decreased again. A lateral part may be connected to the adjusting part may be formed from an elongated ball of fabric, such as a stretch fabric, or a rubber material, for example. Alternatively or additionally, the lateral part may be designed in the manner of a roller blind or of bellows or having lamellas that fold on top of one another. In one potential variant of embodiment, a lateral part of the adjusting device for forming the storage space may also include a combination of at least two of the afore-mentioned variants.

In order for the ease of operation be enhanced, the adjusting device may have a sensor installation by means of which an adjustment of the adjusting part is controllable in a non-contacting manner. For example, the sensor installation has at least one sensor element by means of which an adjustment of the adjusting part is controllable in a non-contacting manner by a user. A sensor element may include, for example, a capacitive sensor by means of which a gesture carried out by a user in the region of the sensor element is capable of being detected as an operating incident for adjusting the adjusting part.

Alternatively or additionally, the sensor installation may have at least one (further) sensor element by means of which an adjustment of the adjusting part is controllable in an automatic manner as a function of a loading state of the storage space. While the variant having at least one sensor element for control by a user, as explained above, requires an operating incident consciously generated by a user in order for adjustment of the adjusting part to be triggered, a self-acting adjustment of the adjusting part is provided in the case of the last-mentioned variant. For example, the weight and/or the size of items received in the storage space is identified by way of the at least one sensor element so as to automatically trigger an adaptation of the volume of the storage space. For example, if it is detected by the sensor that the weight and/or the size of items received in the storage space exceeds a memorized threshold value, the volume is automatically increased by adjusting the adjusting part by a specific defined measure (which depends on the extent to which the threshold value has been exceeded). Alternatively or additionally, an automatic decrease of the volume of the storage space may be capable of being triggered by way of the sensor installation. The volume of the storage space herein is automatically decreased by adjusting the adjusting part (such as in the direction of the initial position) when weight and/or a volume of items received in the storage space under shoots a defined memorized (lower) threshold value. It can be ensured in this manner that the storage space of the storage compartment is adaptable in a variable manner as a function of the loading state of the storage compartment, and the storage space is not larger than immediately required, for example.

The sensor element may detect an operating incident in the form of a gesture carried out by a user for adjusting the adjustment as well as a loading state of the storage space. The sensor element herein may be capable of being operated in different operating modes, for example, so as to be utilizable for control by gestures in a first operating mode and for an automatic adjustment of the adjusting part as a function of a loading state in a second operating mode. The different operating modes herein may depend on the position of the adjusting part, for example.

An insert which is capable of being removed from the adjusting device and is usable separately from the adjusting device as a transport container is provided in one variant. An insert of this type is designed, for example, in the manner of a pouch or a bag and is capable of being established on the adjusting device in the case of an opened storage compartment such that the storage space is at least partially or completely defined by way of the insert. The insert together with the items received therein may thus be retrieved from the storage compartment and including the contents thereof may again be established according to the intended use on the storage compartment.

The adjusting device for the disposal of the insert on the storage compartment according to the intended use may include a holding installation by means of which the insert is fixed and/or centered in a self-acting manner on the adjusting device. It is in this instance ensured by way of the holding installation that the insert is fixed in a position according to the intended use and/or is forced into the position when the insert is disposed on the adjusting device. To this end, the holding installation may include, for example, magnets which interact with magnets attached to the insert. Components of the holding installation is such as, for example, corresponding magnets, may be provided on the adjusting part.

In one or more embodiments, the adjusting part may also be part of the insert and/or the at least one link chain may also be part of the insert. The adjusting part and/or the at least one link chain may thus be designed so as to be retrievable conjointly with the insert. In one variant, alternatively or additionally, not only mechanical components of the adjusting device may be retrieved from the storage compartment conjointly with the insert but optionally also corresponding electronic components such as, for example, parts of the sensor installation, such as sensor element or a plurality of sensor elements for control of the adjusting part by gestures.

In a refinement based thereon, the storage compartment having the adjusting device is configured, for example, as a mobile unit in the form of a storage compartment module or adjusting part module which by way of an interface is capable of being releasably fixed to an attachment location in a vehicle. Such an attachment location may be provided, for example, in a loading space or trunk, on a central console, on a vehicle seat, or a vehicle door so that the storage compartment module including the adjusting device is capable of being fixed thereto and may be completely retrieved when required. The storage compartment module may then be capable of being attached, for example, to a module station (in the manner of a docking station) that is remote from the vehicle. An electric power supply for the storage module may be provided at the module station so as to open and close the storage compartment module in a manner activated by an external force also at the module station and thus in a state not installed in a vehicle. In this variant it is possible, for example, that a user removes the storage compartment model from the vehicle, takes the storage compartment module home, and there plugs the storage module into a module station. The storage compartment may then be opened and closed again in a manner activated by an external force by way of an electric motor of the adjusting device of the storage compartment module. For example, the module station may be configured for setting up on a flat face, for example, and/or for attaching to a wall by way of a wall mounting.

Another embodiment of the present disclosure may include a storage compartment having an adjusting part which is adjustable not only for modifying a volume of a storage space of the storing compartment but also provides an additional function and is consequently designed as a multi-function component. It has already been explained above in this context, that the adjusting part from the initial position thereof may also be adjustable to an adjustment position (table position) in which an external side of the adjusting part that lies opposite an internal side of the adjusting part that faces the storage space defines a depositing face as part of a table formed by the adjusting part. In principle, different functions are thus implemented by way of the adjusting part. The adjusting part serves for defining a variable and thus adaptable volume of the storage space, on the one hand, and for predefining a depositing face of the table, on the other hand. This additional functionality of the adjusting part is independent of the use of at least one link chain for adjusting the adjusting part.

Of course, the adjustment of the adjusting part by means of at least one link chain may also be provided so that the variance and features explained above in this context may also be combined with an adjusting device which has an adjusting part that is adjustable to a table position.

The adjusting part may in principle be configured so as to be plate shaped. For example, the adjusting part configures a front plate of the storage compartment. The front plate by way of the external side thereof defines an external, visible, visible face of the storage compartment when the front plate is situated in the initial position. The front side in the table position of the front plate additionally forms the depositing face for the table defined by the front plate. To this end, it may be provided in one or more embodiments that the front plate by means of the at least one link chain is pivotable to the corresponding table position.

In principle, the adjusting device may include an illumination installation. The storage space may be capable of being illuminated on the inside and/or the depositing face may be capable of being illuminated in the table position of the adjusting part by means of the illumination installation comprising at least one illumination element such as, for example, an LED or OLED.

### BRIEF DESCRIPTION OF THE DRAWINGS

The appended figures in an exemplary manner visualize potential variants of embodiment of the proposed solution.

In the figures:

FIGS. 1A-1B show an exemplary embodiment of an adjusting device according to the invention by way of which a storage compartment for a vehicle is provided, with and without the illustration of lateral parts of the storage compartment;

FIGS. 2A-2B show the adjusting device having an adjusting part formed by a front plate in a table position, with and without a right lateral part;

FIG. 3 shows the adjusting device having the adjusting part in an initial position;

FIG. 4 in a perspective view shows two drive installations of the adjusting device having associated link chains for adjusting the adjusting part of the adjusting device; and

FIG. 5 shows two drive installations of the adjusting device in the plan view.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

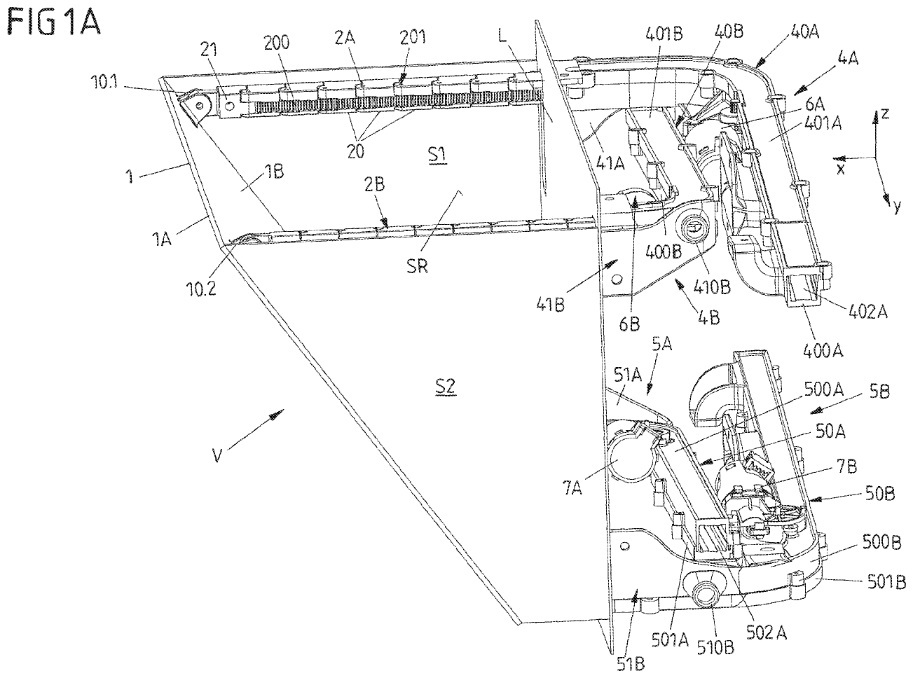

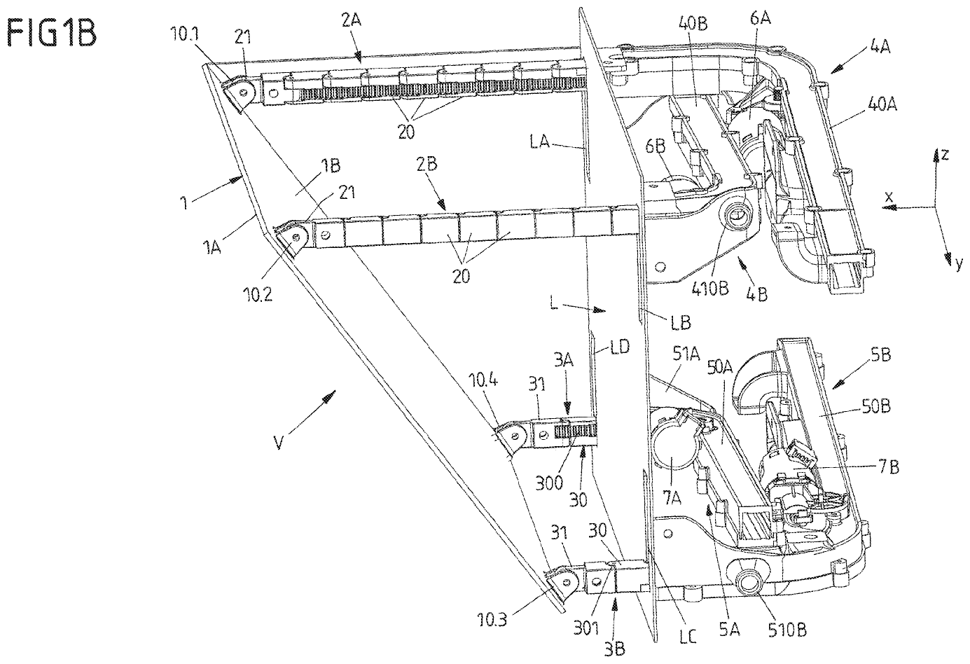

FIGS. 1A-1B, 2A-2B, and 3 show an adjusting device V by way of which a storage compartment for a vehicle is provided in various views and positions of an adjusting part of the adjusting device V that is configured as an adjustable front plate 1. The adjusting device V herein may be configured as a storage compartment or adjusting module which in a pre-assembled for the functional state is capable of being attached in an installation space provided therefore on a dashboard of a motor vehicle. In one variant, attaching the adjusting device V is provided in a trunk, on a center console, on the vehicle seat (for example in the region of a side, on a rear wall, or below the seat cushion of the vehicle seat) or on a vehicle door (for example as part of the door module) of a motor vehicle.

The adjusting device V defines a storage space SR of the storage compartment, the volume thereof being capable of being set in a variable manner by way of the adjustable front plate 1. The front plate 1 herein lies opposite a support part of the adjusting device V in the form of a bearing plate L, the support component defining a rear wall of the storage space SR. Two mutually opposite lateral parts S1 and S2 which define in each case one lateral wall of the storage space SR run between the bearing plate L and the front plate 1. The length of a lateral wall of the storage space SR that is formed by a lateral part S1 or S2 may be modified in that the lateral parts S1 and S2 are in each case configured so as to be flexible and foldable, for example in the manner of bellows, in particular by adjusting the front plate 1. The front plate 1 in the variant of embodiment illustrated along a deployment or adjustment direction x along an adjustment axis or spatial axis x, as well as be pivoted about a pivot axis (about an axis parallel to the spatial axis y) that runs perpendicular to the spatial axis x, may, for example, be adjusted in a translatory manner relative to the bearing plate L. Not only the volume of the storage space SR but also the shape thereof may be variably adapted in such a manner. For example, the storage space SR in FIGS. 1A and 1B is wedge-shaped or funnel-shaped on account of the front plate 1 that is aligned so as to be inclined to the bearing plate L, wherein the larger base area lies at the top and defines an access opening for incorporating items into the storage space SR. However, the storage space SR may also be configured so as to be cuboid, for example, by pivoting the front plate 1 in a corresponding manner.

This variability of the storage space SR is controlled by four link chains 2A, 2B, 3A, and 3B which are connected to the front plate 1 at the four corner points of a virtual rectangle on an internal side 1B of the front plate 1 that faces the storage space SR. Each of the link chains 2A, 2B, 3A, and 3B has an end chain-link 21 or 31 which is in each case articulated on one of four articulation elements 10.1, 10.2, 10.3, and 10.4 that are rigidly connected to the front plate 1.

The four link chains 2A, 2B, and 3A, 3B are presently mutually disposed in such a manner that two (upper) link chains 2A and 2B are deployable in a mutually parallel manner from and retractable into a common xy-plane. The two upper link chains 2A and 2B in turn run so as to be parallel to two further (lower) link chains 3A and 3B which are likewise retractable into and deployable from a common xy-plane. Chain links 20 or 30 of the respective link chain 2A, 2B, of 3A, 3B are in each case connected to one another in unarticulated manner (by way of an articulated connection 201 or 301) such that a non-deployed portion of the respective link chain 2A, 2B, 3A, or 3B is flexible per se. However, the individual chain links 20 or 30 in a deployed state bear on one another in a blocking manner such that a deployed portion of the link chain is (flexibly') rigid and a deployed portion of each link chain 2A, 2B, 3A, or 3B thus projects in the manner of a rod from the bearing plate L and hereby may hold the front plate 1 in a desired spatial position in relation to the bearing plate L. A traction means such as a traction cable which mutually pretensions the individual chain links 20, 30 in order for the chain links 20, 30 in the deployed state to be brought to bear on one another such that the chain links 20, 30 are no longer mutually repositionable may be provided for the blocking bearing of the deployed chain links 20 or 30 of the link chain 2A, 2B, 3A, and 3B. Link chains which become rigid when deployed and otherwise of flexible are widely known in principle.

Drive installations 4A, 4B, 5A, and 5B are part of the adjusting device V for retracting and deploying the link chains 2A, 2B, 3A, and 3B in a manner activated by an external force. Each link chain 2A, 2B, 3A, and 3B herein is assigned in each case one drive installation 4A, 4B, 5A, or 5B such that each of the link chains 2A, 2B, 3A, and 3B is adjustable individually and thus independently of the other link chains. Each drive installation 4A, 4B, 5A, and 5B has inter alia a chain housing 40A, 40B, 50A, or 50B in which a retracted portion of the respective associated link chain 2A, 2B, 3A, or 3B may be received.

Each of the chain housings 40A, 40B, 50A, and 50B herein is configured so as to be L-shaped. The associated link chain 2A, 2B, 3A, and 3B with in each L-shaped chain housing 40A, 40B, 50A, and 50B is thus deflected by approx. 90° when retracting and when the individual chain links 20 or 30 no longer bear on one another in a blocking manner. The adjusting device V in such a manner may be of a comparatively compact construction and, despite a comparatively large adjustment path front plate 1 predefined by the link chains 2A, 2B, 3A, and 3B, may be conceived so as to be shorter along the x-axis and thus to require less installation space.

Each chain housing 40A, 40B, 50A, or 50B configures a housing part 400A, 400B, 500A, or 500B having a guide duct 402A, 402B, 502A, 502B for the retracted portion of the respective link chain 2A, 2B, 3A, or 3B. For simpler assembling and for protecting the respective guide duct 402A, 402B, 502A, or 502A from dirt, the respective housing part 400A, 400B, 500A, or 500B is presently closed off by a cover 401A, 401B, 501A, or 501B that is capable of being separately assembled.

In order for the attachment installations 4A, 4B, 5A, and 5B be able to be accommodated in an ideally compact manner behind the bearing plate L, the drive installations 4A, 4B, 5A, and 5B are disposed on top of one another in pairs. Two (upper) drive installations 4A and 4B, along a spatial direction z that runs so as to be perpendicular to the spatial direction x along which the front plate (1 may be adjusted in a translatory manner by way of the link chains 2A, 2B, 3A, and 3B, are thus disposed above the two further (lower) drive installations 5A and 5B. Furthermore, it is provided in the case of each pair of drive installations 4A, 4B, and 5A, 5B that one chain housing 40A or 50B extends at least partially about the other chain housing 40B or 50A. Furthermore, the chain housings 40A, 40B, and 50A, 50B run so as to be partially mutually inclined.

The drive installations 4A, 4B, and 5A, 5B for the upper and the lower chain links 2A, 2B, and 3A, 3B presently are configured in identical pairs. In other words, the drive installation 4A and 4B for the upper link chains 2A and 2B are configured so as to be identical to the drive installations 5A and 5B for the lower link chains 3A and 3B. The upper drive installations 4A and 4B are merely assembled so as to be rotated by 180°. Accordingly, only two different types are required for the four drive installations 4A/5B, 4B/5A four driving the total of four link chains 2A, 2B, 3A, and 3B in a manner activated by an external force.

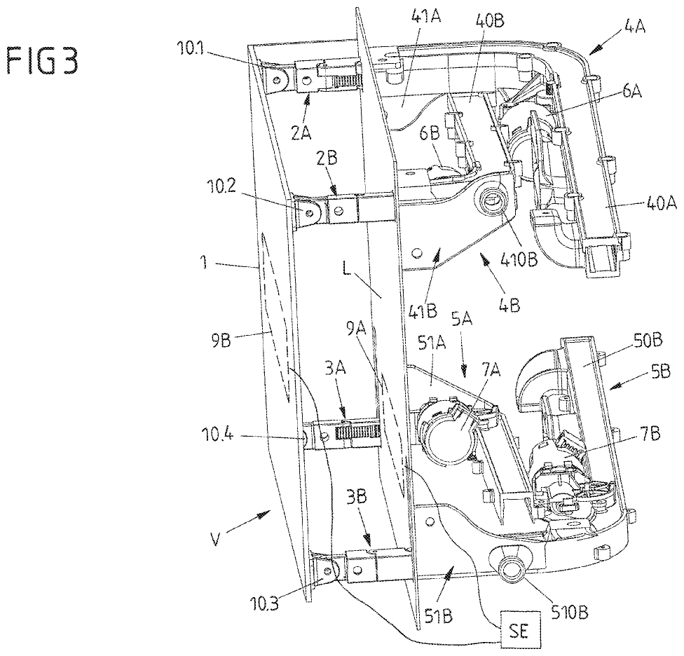

Each drive installation 4A, 4B, 5A, and 5B presently has an electromotive drive 6A, 6B, 7A, or 7B which is established on the respective chain housing 40A, 40B, 50A, or 50B. An individual link chain 2A, 2B, 3A, or 3B may be deployed from the respective chain housing 40A, 40B, 50A, or 50B by way of the electromotive drive 6A, 6B, 7A, or 7B such that the chain links 20, 30 of one link chains 2A, 2B, 3A, or 3B are pushed out of an associated deployment opening in the form of a longitudinal slot LA, LW, LC, or LD on the bearing plate L and thus may adjust the front plate 1 toward the front along the spatial axis x. In the deployment along the spatial axis x the volume of the storage space SR is increased in relation to an initial position which is illustrated in FIG. 3 and in which the front plate 1 presently is at a minor spacing from the bearing plate L, presently so as to be substantially parallel to the bearing plate L.

When only the upper link chains 2A, 2B are then deployed from the initial position, for example, the front plate 1 is pivoted about the lower articulation elements 10.3 and 10.4 (and thus about a lower pivot axis defined herein) on which the lower link chains 3A and 3B are articulated. On account thereof, not only the shape of the storage space SR is modified such that the storage space SR appears to be wedge-shaped or funnel-shaped, but also the volume of the storage space SR is increased as compared to the initial position of the front plate 1. By contrast, when the lower link chains 3A, 3B are deployed along the spatial axis x while the upper link chains 2A and 2B remain arrested or are deployed more slowly, the front plate 1 is pivoted about the upper articulation elements 10.2 and 10.1 (and thus about an upper pivot axis defined herein), and the storage space SR is increased on account thereof, optionally with the upper link chains 2A and 2B being arrested, without achieving or increasing herein an access opening to the storage space SR. The link chains 2A, 2B, 3A, and 3B herein may in principle also be deployed in a mutually non-synchronous manner. However, asynchronous adjustment of all link chains 2A, 2B, 3A, and 3B is ultimately possible so as to achieve a purely translatory adjustment of the front plate 1 (that is to say without any superimposed pivoting movement at the articulation elements 10.1 10.4).

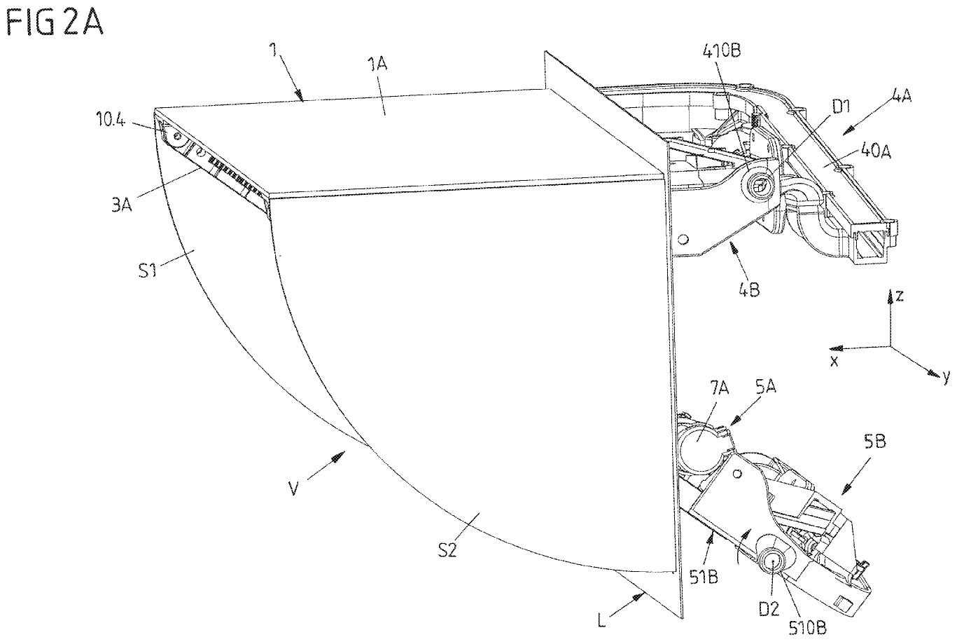

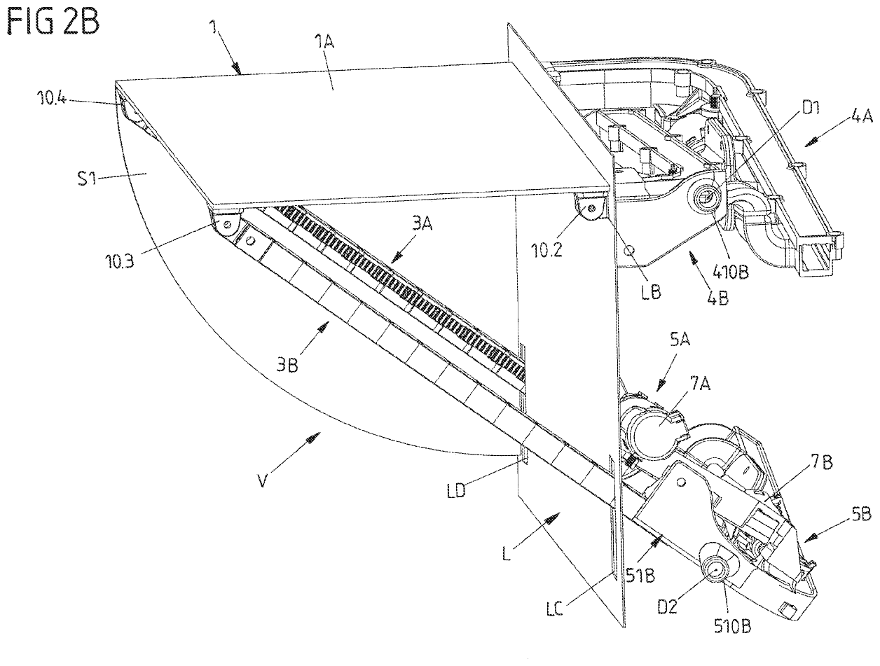

Additionally to adjusting the front plate 12 different first adjustment positions so as to vary the volume and/or the shape of the storage space SR, the front plate 1 presently by way of the link-chain drive having the four link chains 2A, 2B, 3A, and 3B thereof of the adjusting device V is also adjustable to a second adjustment position, referred to as the “table position” which is illustrated in FIGS. 2A and 2B. The front plate 1 herein by way of the two lower link chains 3A and 3B, with the upper link chains 2A and 2B arrested, is pivoted upward such that an external side 1A of the front plate 1 defines a deposition face as part of a table formed by the front plate 1. The front plate 1 herein by the two lower link chains 3A and 3B is pivoted about the end chain links 21 of the upper link chains 2A, 2B such that the front plate 1 runs so as to be substantially horizontal and items may be set down on the external side 1A of the front plate 1.

In order for the front plate 1 for assuming the table position to be pivoted upward by means of the two lower link chains 3A, 3B, the drive installations 5A and 5B of the lower link chains 3A, 3B by way of a bearing portion 51A and 51B are mounted so as to be rotatable relative to the support plate L. Each bearing portion 51A and 51B of the two drive installations 5A and 5B herein configures a rotary bearing journal 510A or 510B. The two drive installations 5A and 5B including the chain housings 50A and 50B thereof by way of the two rotary bearing journals 510A, 510B are then mounted so as to be rotatable about a rotation axis D2 relative to the bearing plate L. By way of the deployment openings for the link chains 3A and 3B that are embodied as longitudinal slots LC and LD on the bearing plate L it is here in also ensured that the individual link chains 3A and 3B across a defined angular range may be deployed obliquely to the bearing plate L. The link chains 3A and 3B may thus not only be deployed so as to be substantially perpendicular to the bearing plate L but also at a variable angle in a range from 90° to, for example, 45°, in particular in a range from 90° to 60°, to the bearing plate L.

The rotatable mounting of the drive installations 5A and 5B furthermore also serves for equalizing different spacings in the case of upper and lower link chains 2A, 2B, 3A, and 3B that are deployed to a great extent. Against this background, the drive installations 4A and 4B may optionally also be mounted so as to be rotatable relative to the bearing plate L by way of rotary bearing journals 410A and 410B that are configured on the bearing portions 41A and 41B.

The volume of the storage space SR may in principle be variably adjustable in a manner controlled by a user. Consequently, a user may set the size of the storage space SR by retracting and deploying the four link chains 2A, 2B, 3A, and 3B depending on the desired space requirement.

Alternatively or additionally, a self-acting adaptation of the storage space volume may also be provided. To this end, the adjusting device V according to FIG. 3 has at least one sensor element 9A on the bearing plate L, for example. A loading state of the storage space SR in this instance is capable of being detected by way of the sensor element 9A, for example, and a size of the storage space SR is capable of being automatically adapted as a function thereof. To this end, the sensor element 9A may operate in a capacitive or optical manner and identify to what extent the available storage space SR in the current adjustment position of the front plate 1 is utilized. In this manner, it may be detected by a sensor whether the volume of the storage space SR should optionally be increased or decreased in order for further items to be able to be received or the space requirement of the storage compartment be decreased.

The sensor element 9A herein is coupled to a sensor installation SE, for example, which has an evaluation logic for measured signals received by the sensor element 9A. When a loading state which is intended to lead to an automatic adaptation of the volume of the storage space SR is identified by way of the evaluation logic of the sensor installation SE, the sensor installation SE correspondingly actuates the drives 6A, 6B, 7A, and 7B of the drive installations 4A, 4B, 5A, and 5B so as to deploy and/or retract the link chains 2A, 2B, 3A, and 3B for the adjustment of the front plate 1.

Alternatively or additionally to sensor element 9A four detecting a loading state of the storage space SR, the adjustment direction V may also have a sensor element 9B on the front plate 1 so as to detect in a non-contacting manner an operating incident by a user in order for the storage space SR be rendered accessible to the user and/or for the storage space SR be closed. Part of the sensor element 9B that herein is disposed on the front plate 1 may be at least one electrode, for example for detecting in a capacitive manner a gesture of a user carried out in front of the external side is 1A of the front plate 1 as an operating incident for opening or closing the storage compartment. Such a sensor element 9B in this instance may thus also be coupled in a corresponding manner to a sensor installation SE for controlling the drives 6A, 6B, 7A, and 7B.

In principle, only one sensor element 9A or 9B by means of which an operating incident in the form of a gesture carried out by a user for adjusting the front plate 1 as well as a loading state of the storage SR is capable of being detected may also be provided. The respective sensor element 9A and 9B herein may also be capable of being operated in different operating modes, for example, so as to be utilizable for control by gesture in a first operating mode and for an automatic adjustment of the front plate 1 as a function of a loading state in a second operating mode.

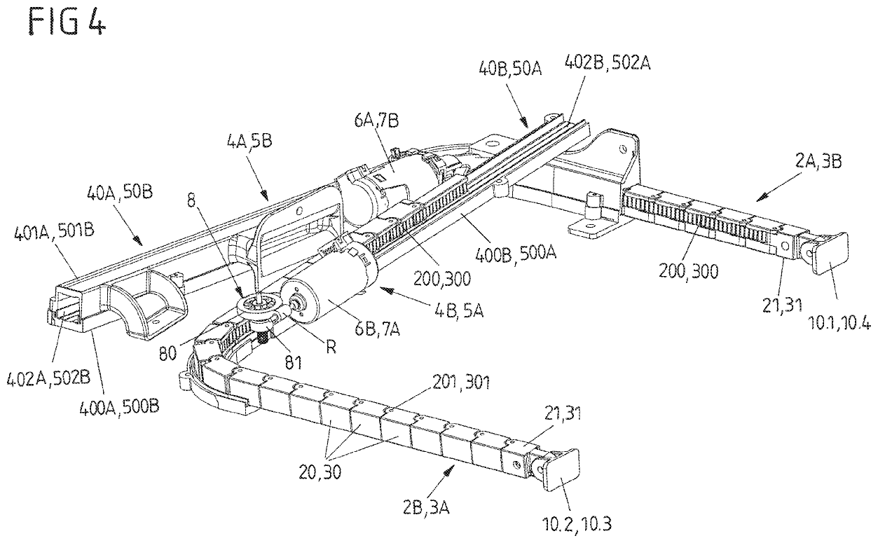

The drives 6A, 6B, 7A, and 7B may be electromotive and by way of the gearbox unit act on the chain links 20, 30 of the link chains 2A, 2B, 3A, and 3B so as to adjust the latter. Each drive 6A, 6B, 7A, or 7B presently is coupled to a worm gear mechanism, for example, so as to convert a drive torque generated by the respective drive 6A, 6B, 7A, or 7B for retracting and deploying the associated link chain 2A, 2B, 3A, or 3B. A drive 6B or 7A, illustrated in exemplary manner in FIG. 4, thus acts in each case by way of a gear wheel element in the form of a worm R on a worm gear 80 of a rotatably mounted drive element 8. A chain link here wheel 81 is provided on the drive element 8 so as to be rotationally fixed to the worm gear 80. The chain link gear wheel 81 meshes with a toothed drive face 200 or 300 of A chain link 20 or 30. In that a torque by way of the worm R is transmitted to the worm gear 80 and the chain link gear wheel 81 is thus rotated in one of two potential rotating directions, a chain link 20 or 30 that meshes with the chain-link gear wheel 81 is pushed in one or the other direction along the guide duct 402B, 502A. In that the successive chain links 20 and 30 then likewise mesh with the chain-link gear wheel 81, the rotating movement of the chain-link gear wheel 81 results in the respective link chain 2A, 2B, 3A, or 3B being retracted or deployed, depending on the rotating direction.

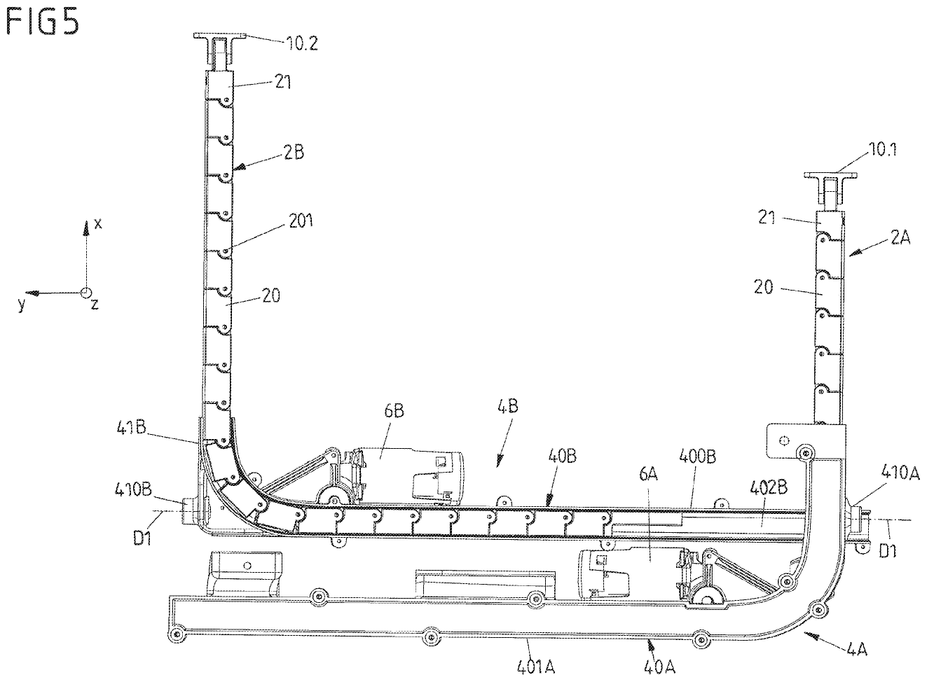

As is yet again visualized by way of the plan view of FIG. 5, the use of dedicated drive is 6A, 6B, 7A, 7B for a pair of upper or lower link chains 2A/2B and 3A/3B also permits an un-synchronous adjustment of the link chains 2A, 2B, or 3A, 3B of a pair of link chains 2A/2B and 3A/3B. The front plate 1 may thus not only be pivoted about pivot axes that run so as to be parallel to the spatial axis y and be displaced parallel to the spatial axis x. Rather, a pivoting movement about a further pivot axis which runs so as to be parallel to the spatial axis z which is oriented so as to be perpendicular to the two afore-mentioned spatial axes x and y is also possible.

The front plate 1 by way of the use of the link chains 2A, 2B, 3A, and 3B is thus variably adjustable in different ways so as to be able to adapt the shape and/or the volume of the storage space SR. Furthermore, the front plate 1 which forms an external visible face of the storage compartment, by way of the use of the link chains 2A, 2B, 3A, and 3B is also pivotable to a table position such that various (comfort) functions may be reproduced by way of a storage compartment having the adjustment direction V. In this context it is also to be pointed out that the use of four link chains 2A, 2B, 3A, and 3B is of course not mandatory for the illustrated adjustability of the front plate 1. A translatory adjustability and pivotability of the front plate 1 could also be achieved, for example, by way of two link chains, and upper and lower link chain.

As one example, a holding installation for establishing and arresting a storage-space insert may be provided on the deployed portions of the link chains 2A, 2B, 3A, and 3B and/or the flexible lateral parts 51 and S2. Such an insert may be configured so as to be pouch-shaped or bag-shaped, for example, and/or integrates the flexible lateral parts 51 and S2, herein can be separable from the bearing plate L in the case of an opened storage compartment. The insert, independent of the disposal in the vehicle, may thus be capable of being utilized as a transport container.

The holding installation for such an insert may be formed, for example, by hooks on a chain link 20, 30 or a plurality of chain links 20, 30, and a corresponding insert being capable of being cooked on the hooks. Alternatively or additionally, at least one magnet may be provided for establishing the insert according to the intended use on the link chains 2A, 2B, 3A, and 3B and/or the front plate 1 as part of the holding installation.

A rack may also be provided instead of the at least one link chain 2A, 2B, 3A, or 3B. The lower chain links 3A and 3B in one variant may furthermore be replaced by a scissor arm or by a plurality of scissor arms which engage on the front plate 1. Instead of a link-chain drive having the link chains 2A, 2B, 3A, and 3B, a lever mechanism may in principle be provided for varying the volume of the storage space SR in a manner activated by an external force, on the one hand, and for pivoting the front plate 1 to a table position in which the front plate 1 is capable of being utilized as a tabletop, on the other hand.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE SIGNS

1 Front plate/table top (adjusting part)

10.1, 10.2, 10.3, 10.4 Articulation element

1A External side/depositing face

1B Internal side

20 Chain link

200 Driving face

201 Articulated connection

21 End chain link

2A, 2B Link chain (adjusting element)

30 Chain link

300 Driving face

301 Articulated connection

31 End chain link

3A, 3B Link chain (adjusting element)

400A, 400B Housing part

401A, 401B Cover

42A, 402B Guide duct

40A, 40B Chain housing

410A, 410B Rotary bearing journal

41A, 41B Bearing portion

4A, 4B Drive installation

500A, 500B Housing part

501A, 501B Cover

502A, 502B Guide duct

50A, 50B Chain housing

510A, 510B Rotary bearing journal

51A, 51B Bearing portion

5A, 5B Drive installation

6A, 6B Drive

7A, 7B Drive

8 Driving element

80 Worm gear

81 Chain link gear wheel

9A, 9B Sensor element

D1, D2 Rotation axis

L Bearing plate (support component)

LA, LB, LC, LD Longitudinal slot (Deployment opening)

R Worm (gear element)

S1, S2 Lateral part

SE Sensor installation

SR Storage space

V Adjusting device

1. An adjusting device for a storage compartment having a variable storage space, the adjusting device comprising:
an adjustable part including a wall that at least partially delimits the variable storage space, wherein the variable storage space is adjustable between an initial position, defining a first volume, and an adjustment position, defining a second volume, wherein the first volume and the second volume are different from one another; and,
an adjusting part including a link chain provided with a plurality of chain links, wherein the adjusting part is configured to adjust the adjustable part between the initial position and the adjustment position.

2. The adjusting device of claim 1, wherein the adjusting part is pivotable and adjustable in a translatory manner by means of the link chain.

3. The adjusting device of claim 2, wherein the adjustable part is pivotable by at least 45° about a pivot axis, wherein the pivot axis extends in a direction substantially or exactly perpendicular to an adjustment direction, wherein the adjustable part is configured to translate in the adjustment direction from the initial position.

4. The adjusting device of claim 1, wherein the adjustable part includes an external side, wherein when the adjustable part is in the initial position, the external side forms an external visible face of the storage compartment.

5. The adjusting device of claim 1, wherein the link chain by means of at least one drive installation is adjustable in a manner activated by an external force.

6. The adjusting device of claim 5, further comprising a chain housing, wherein the link chain is at least partially deployable from the chain housing, wherein each of the chain links of the link chain are each repositionable in the chain housing such that a portion of the link chain disposed within the chain housing is flexible and configured to be deflected.

7. The adjusting device of claim 6, wherein the chain housing is configured to deflect the link chain at least 45° when moving into a guide formed by the chain housing.

8. The adjusting device of claim 6, wherein the chain housing is L-shaped or spiral-shaped.

9. The adjusting device of claim 6, wherein the chain housing is configured to rotate about a rotation axis.

10. The adjusting device of claim 1, wherein the adjustable device includes a plurality of link chains configured to adjust the adjustable part.

11. The adjusting device of claim 10, wherein at least two of the link chains of the plurality of link chains are each adjustable in a mutually independent manner to vary the volume and/or a shape of the storage space.

12. The adjusting device of claim 10, wherein each of the link chains or one pair of the plurality link chains are assigned to a drive installation of the adjusting part, so that each of the chain links or the one pair of the plurality of link chains are adjustable in a manner activated by an external force.

13. The adjusting device of claim 12, wherein the plurality of link chains includes four link chains connected to the adjustable part at one of four corner points of a virtual rectangle.

14. The adjusting device of claim 13, wherein two link chains of the four link chains are adjustable along a first virtual plane, and two other link chains of the four link chains are adjustable along a second virtual plane, wherein the second virtual plane is parallel to the first virtual plane.

15. The adjusting device of claim 14, wherein the adjusting part (includes at least two chain housings) disposed on top of one another along a spatial axis, wherein the spatial axis extends in a direction that is substantially perpendicular to an adjustment direction, wherein the adjustable part is configured to translate in the adjustment direction from the initial position.

16. The adjusting device of claim 15, wherein the at least two chain housings includes a first chain housing and a second chain housing, wherein the second chain housing extends from the first chain housing.

17. The adjusting device of claim 1, further comprising at least one flexible lateral part, configured to be rolled and/or folded up, and a second wall, wherein as the flexible lateral part is either rolled and/or folded up the second wall delimits the storage space.

18. The adjusting device of claim 1, further comprising a sensor installation coupled to the adjustable part and controllable in a non-contacting manner.

19. The adjusting device of claim 18, wherein the sensor installation includes a first sensor element and a second sensor element, wherein the first sensor element is configured such that a user may control an adjustment of the adjustable part in a non-contacting manner by a user, and/or wherein the second sensor element is configured to control an adjustment of the adjustable part is in an automatic manner as a function of a loading state of the storage space.

20. The adjusting device of claim 1, wherein the adjustable part includes an insert, wherein the insert is removable from the adjusting part and is configured for use separately from the adjustable part as a transport container.

21. The adjusting device of claim 20, further comprising a holding installation, wherein when the insert is disposed on the adjusting part, the holding installation is configured to be fixed and/or centered in a self-acting manner on the adjusting part.

22. The adjusting device of claim 20, wherein the adjustable part and/or the link chain are/is part of the insert.

23. An adjusting device for use with a storage compartment forming a storage space, wherein a volume of the storage space is variable, the adjusting device comprising:
an adjustable part including a wall that at least partially delimits the storage space, wherein the adjustable part is adjustable at least between an initial position, defining a first volume, and an adjustment position, defining a second volume, wherein the first volume of is different than the second volume, wherein when the adjustable part is in the adjustment position,
an external side of the adjustable part that lies opposite an internal side of the adjustable part that faces the storage space defines a depositing face as part of a table formed by the adjustable part.

24. The adjusting part of claim 23, wherein the adjustable part is plate-shaped.
